(19) United States
(12) Patent Application Publication
(10) Pub. No.: US 2013/0288838 A1
(43) Pub. Date: Oct. 31, 2013

(54) STEEL FOR BELT-TYPE CVT PULLEY AND BELT-TYPE CVT PULLEY

(71) Applicants: Gen KATO, Saitama (JP); Mitsuru FUJIMOTO, Saitama (JP); Hiroki TERADA, Aichi (JP); Sinichiro KATO, Aichi (JP); Katsuya YAMAGUCHI, Aichi (JP); Makoto HARITANI, Aichi (JP)

(72) Inventors: Gen KATO, Saitama (JP); Mitsuru FUJIMOTO, Saitama (JP); Hiroki TERADA, Aichi (JP); Sinichiro KATO, Aichi (JP); Katsuya YAMAGUCHI, Aichi (JP); Makoto HARITANI, Aichi (JP)

(73) Assignees: DAIDO STEEL CO., LTD., Aichi (JP); HONDA MOTOR CO., LTD., Tokyo (JP)

(21) Appl. No.: 13/868,547

(22) Filed: Apr. 23, 2013

(30) Foreign Application Priority Data
Apr. 25, 2012 (JP) 2012-099407

(51) Int. Cl. F16H 55/36; C22C 38/48; C22C 38/44; C22C 38/00; C22C 38/06; C22C 38/04; C22C 38/02; C22C 38/50; C22C 38/42

(52) U.S. Cl. CPC F16H 55/36; C22C 38/50; C22C 38/48; C22C 38/44; C22C 38/42; C22C 38/06; C22C 38/04; C22C 38/02; C22C 38/001
USPC 474/166; 420/91

(57) ABSTRACT

A steel for a belt-type CVT pulley made of chromium steel or chromium molybdenum steel according to the present invention has a component composition that satisfies predetermined formulae regarding the mass % of Mn, Ni, Cr, Mo, Si, Nb and Ti. In addition, the steel for a belt-type CVT pulley contains, in terms of mass %, as essentially added elements, 0.15% to 0.25% of C, 0.40% to 1.00% of Mn, more than 1.80% and 2.20% or less of Cr, 0.005% to 0.030% of N, and 0.010% to 0.060% of Al, and as arbitrarily added elements, 0.20% or less of Si, 0.03% or less of P, 0.05% or less of S, 0.3% or less of Cu, 0.3% or less of Ni, and 0.2% or less of Mo, with the remainder being Fe and inevitable impurities.

### FIELD OF THE INVENTION

The present invention relates to a steel for a pulley made of chromium steel or chromium molybdenum steel, which is used for a pulley in a belt-type CVT which is one type of transmission for automobiles or the like, and a belt-type CVT pulley; and particularly to a steel for a pulley, which is a belt-type CVT pulley provided through a hot forging process and a subsequent surface hardening treatment under heating such as a carburization treatment, and a belt-type CVT pulley.

### BACKGROUND OF THE INVENTION

In a belt-type continuously variable transmission (CVT) which is one type of transmission for vehicles or the like, a steel belt is wound between a pair of pulleys at an input side and an output side, and power is transmitted between two pulleys through the steel belt. For such a pulley, as described in Patent Documents 1 to 3, a steel for a pulley which is based on chromium steel or chromium molybdenum steel specified in JIS G4053 and has an adjusted component composition is used.

As an example, Patent Document 1 discloses a steel for a pulley having a component composition of, in terms of mass %, C: 0.20, Si: 0.25, Mn: 0.70, P: 0.018, S: 0.025, Cr: 0.50, Mo: 0.18, and Ni: 0.50. Similarly, Patent Document 2 discloses a steel for a pulley having a component composition of, in terms of mass %, C: 0.21, Si: 0.23, Mn: 0.75, P: 0.016, S: 0.020, Cr: 0.55, Mo: 0.18, and Ni: 0.50. In addition, Patent Document 3 discloses a steel for a pulley having a component composition of, in terms of mass %, C: 0.22, Si: 0.20, Mn: 0.65, P: 0.015, S: 0.019, Cr: 0.90, Mo: 0.16, and Ni: 1.80. In Patent Documents 1 to 3, it is described that a steel for a pulley which satisfies a variety of mechanical characteristics such as the abrasion resistance necessary for a pulley in a belt-type CVT can be provided by increasing the added amount of Si, Mn and Mo, and furthermore, additionally adding or increasing any of Nb, Ti, Ni, B, and the like to the component compositions of a variety of steels specified in JIS G4053.

In addition, Patent Document 4 discloses a component composition of a steel for case-hardening for mechanical parts including a belt-type CVT pulley provided through a surface hardening treatment under heating such as a carburization treatment. As an example, a steel having a component composition of, in terms of mass %, C: 0.21, Si: 0.18, Mn: 1.10, P: 0.010, S: 0.02, Ni: 1.52, Cr: 1.06, Al: 0.051, Ti: 0.015, Nb: 0.04, N: 0.0231, and 0: 0.0008 is disclosed. The steel having such a component composition is described to be not only excellent in terms of mechanical characteristics such as rolling contact fatigue but also excellent in terms of molding workability, and to be capable of sufficiently suppressing coarsening of crystal grains even with a surface hardening treatment under heating. The suppression of coarsening of crystal grains consequently improves impact characteristics such as rolling contact fatigue. As a similar steel, there is also described a component composition of a steel which is chromium steel, chromium molybdenum steel, or nickel chromium molybdenum steel to which Al, Nb and Ti are added as essential elements, and furthermore, elements arbitrarily selected from Cu, Mo, B, Pb, Mg, Ca, Te, Zr, V and REM are optionally added additionally.

Patent Document 1 : JP-A-2007-262470

Patent Document 2 : JP-A-2009-068608

Patent Document 3 : JP-A-2009-068609

Patent Document 4 : JP-A-2007-113071

### SUMMARY OF THE INVENTION

Generally, the abrasion resistance or fatigue strength of steel can be improved by increasing the hardness or tensile strength of the steel through adjustment of alloy elements. However, in a case in which alloy elements are excessively added or the like, the deformation resistance increases during hot forging, and the workability degrades. Particularly, in hot forging of a part having a highly flat shape such as a belt-type CVT pulley having a large umbrella portion, contact area with a mold increases. That is, when the deformation resistance is large in a hot region, the forging load increases in proportion to the contact area, and molding becomes extremely difficult.

Therefore, there is a demand for a belt-type CVT pulley, in which a steel is subjected to a hot forging process to possess the shape of the belt-type CVT pulley and then the abrasion resistance and the fatigue strength of the belt-type CVT pulley are improved by carrying out a surface hardening treatment under heating such as a carburization treatment mainly on a portion coming into contact with a steel belt, which requires a particularly high abrasion resistance or fatigue strength.

The invention has been made in consideration of such circumstances, and an object of the invention is to provide a belt-type CVT pulley of which the abrasion resistance and the fatigue strength are improved by carrying out a surface hardening treatment under heating such as a carburization treatment after hot forging, that is, a steel for a belt-type CVT pulley which enables hot forging of the shape of a belt-type CVT pulley without extremely increasing the deformation resistance during hot forging, suppresses coarsening of crystal grains under heating such as a carburization treatment, and can secure the abrasion resistance and the fatigue strength, and a belt-type CVT pulley using the same.

A steel for a belt-type CVT pulley according to the invention is a steel for a belt-type CVT pulley made of chromium steel or chromium molybdenum steel, the steel for a belt-type CVT pulley having a component composition that satisfies:

−2.73×[Mn]+6.42×[Ni]+2.20×[Cr]+1.25×[Mo]≧2.0, (formula 1):

10×[Si]+[Mn]+[Cr]≦4.3, and (formula 2):

7.00×[Si]+3.60×[Mn]+1.20×[Cr]+22.3×[Mo]+42.3×[Nb]+39.5×[Ti]≦8.0, (formula 3):

wherein [M] represents a mass % of an element M;

and

the steel for a belt-type CVT pulley comprising, in terms of mass %, as essentially added elements,

0.15% to 0.25% of C,

0.40% to 1.00% of Mn,

more than 1.80% and 2.20% or less of Cr,

0.005% to 0.030% of N, and

0.010% to 0.060% of Al, and

as arbitrarily added elements,

0.20% or less of Si,

0.03% or less of P,

0.05% or less of S,

0.3% or less of Cu,

0.3% or less of Ni, and

0.2% or less of Mo,

with the remainder being Fe and inevitable impurities.

According to the present invention, when the formulae 1 to 3 are satisfied and the component composition is adjusted to a predetermined range, the deformation resistance is maintained at a low level during hot forging, and therefore the abrasion resistance and fatigue strength of the obtained belt-type CVT pulley can be improved compared to a pulley made of a conventional material.

According to the present invention, the steel for a belt-type CVT pulley may further include, as an arbitrarily added element, at least one of: 0.05% or less of Nb and 0.05% or less of Ti. According to this invention, the abrasion resistance and fatigue strength of the obtained belt-type CVT pulley can be improved without significantly increasing the deformation resistance during hot forging.

Furthermore, a belt-type CVT pulley according to the present invention is a belt-type CVT pulley, which comprises the above-mentioned steel for a belt-type CVT pulley worked into a predetermined shape and then subjected to a carburization treatment, whereby the belt-type CVT pulley has a surface layer hardness of 650 Hv or more.

According to the present invention, a belt-type CVT pulley having improved abrasion resistance and fatigue strength can be provided without having an influence on the deformation resistance during hot forging.

### BRIEF DESCRIPTION OF THE DRAWINGS

FIG. 1 is a perspective view showing an appearance of a testing actual pulley.

FIG. 2 is a view showing a manufacturing process of the testing actual pulley.

FIG. 3 is a cross-sectional view of a bending fatigue tester for an actual pulley.

FIG. 4 is a view showing the relationship between the hardness and the abrasion ratio.

FIG. 5 is a view showing the relationship between the fracture toughness parameter and the abrasion ratio.

FIG. 6 is a view showing the relationship between the grain boundary oxidation parameter and the fatigue limit stress ratio.

FIG. 7 is a view showing the relationship between the forging parameter and the forging load ratio.

### DESCRIPTION OF REFERENCE NUMERALS AND SIGNS

1 TESTING ACTUAL PULLEY

2 CONTACT AREA

3 STEEL BELT

4 OUTPUT SIDE PULLEY

10 BELT-TYPE CVT

20 BENDING FATIGUE TESTER FOR ACTUAL PULLEY

### DETAILED DESCRIPTION OF THE INVENTION

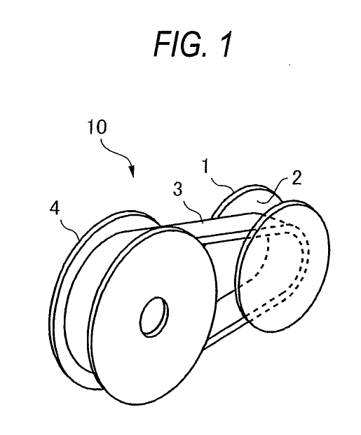

The present inventors repeated thorough studies in order to obtain a steel for a pulley, in which the abrasion resistance and the fatigue strength are further improved by making an amendment based on the component composition of chromium steel or chromium molybdenum steel specified in JIS G4053 which is known as a steel for a belt-type CVT pulley, and, at the same time, the deformation resistance can be decreased when hot forging is carried out on the shape of an umbrella-type pulley (refer to FIG. 1). As a result, it was found that the content of Cr has a large influence on a steel for a pulley. Hereinafter, the detail will be described.

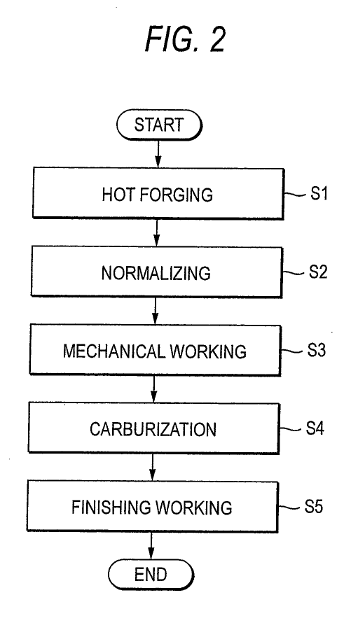

Firstly, a method of manufacturing a testing actual pulley 1 in a belt-type CVT 10 as shown in FIG. 1 will be described using Table 1 and FIG. 2. Meanwhile, a steel belt 3 is wound between the testing actual pulley 1 on the input side and an output side pulley 4.

As shown in Table 1, steel ingots having component compositions shown in Examples 1 to 13 and Comparative examples 1 to 12 were prepared respectively, and treatments in the respective processes as shown in FIG. 2 were carried out on the steel ingots so as to manufacture the testing actual pulleys 1. Meanwhile, the component compositions shown in Table 1 are measured values, and zero indicates that the value is a measurement limit or less.

TABLE 1

| | C | Si | Mn | P | S | Cu | Ni | Cr | Mo | N | Al | Nb | Ti |
|---|---|---|---|---|---|---|---|---|---|---|---|---|---|
| Example 1 | 0.20 | 0.08 | 0.76 | 0.016 | 0.014 | 0.11 | 0.09 | 1.85 | 0.00 | 0.021 | 0.039 | 0.000 | 0.000 |
| Example 2 | 0.16 | 0.09 | 0.71 | 0.002 | 0.042 | 0.08 | 0.10 | 1.87 | 0.01 | 0.006 | 0.032 | 0.000 | 0.001 |
| Example 3 | 0.25 | 0.05 | 0.80 | 0.001 | 0.048 | 0.16 | 0.08 | 1.97 | 0.02 | 0.014 | 0.029 | 0.000 | 0.000 |
| Example 4 | 0.21 | 0.02 | 0.98 | 0.008 | 0.018 | 0.21 | 0.10 | 1.85 | 0.01 | 0.019 | 0.042 | 0.000 | 0.000 |
| Example 5 | 0.20 | 0.20 | 0.47 | 0.005 | 0.012 | 0.03 | 0.09 | 1.81 | 0.12 | 0.022 | 0.021 | 0.000 | 0.000 |
| Example 6 | 0.22 | 0.07 | 0.69 | 0.018 | 0.021 | 0.07 | 0.03 | 2.19 | 0.01 | 0.021 | 0.011 | 0.000 | 0.000 |
| Example 7 | 0.20 | 0.17 | 0.54 | 0.021 | 0.017 | 0.30 | 0.08 | 1.88 | 0.05 | 0.023 | 0.015 | 0.001 | 0.000 |
| Example 8 | 0.17 | 0.10 | 0.58 | 0.008 | 0.033 | 0.13 | 0.09 | 2.05 | 0.02 | 0.025 | 0.060 | 0.000 | 0.000 |
| Example 9 | 0.23 | 0.08 | 0.61 | 0.025 | 0.003 | 0.04 | 0.08 | 1.94 | 0.01 | 0.020 | 0.052 | 0.000 | 0.000 |
| Example 10 | 0.15 | 0.03 | 0.41 | 0.029 | 0.006 | 0.08 | 0.08 | 1.82 | 0.18 | 0.029 | 0.038 | 0.000 | 0.000 |
| Example 11 | 0.21 | 0.13 | 0.51 | 0.013 | 0.020 | 0.23 | 0.29 | 1.81 | 0.08 | 0.010 | 0.031 | 0.000 | 0.000 |
| Example 12 | 0.19 | 0.09 | 0.45 | 0.014 | 0.013 | 0.18 | 0.09 | 1.89 | 0.03 | 0.022 | 0.038 | 0.050 | 0.001 |
| Example 13 | 0.21 | 0.03 | 0.47 | 0.008 | 0.015 | 0.21 | 0.05 | 1.85 | 0.01 | 0.019 | 0.036 | 0.000 | 0.049 |
| Comparative | 0.20 | 0.25 | 0.80 | 0.020 | 0.015 | 0.09 | 0.07 | 1.16 | 0.15 | 0.025 | 0.045 | 0.000 | 0.001 |
| Example 1 | | | | | | | | | | | | | |
| Comparative | 0.21 | 0.35 | 0.72 | 0.017 | 0.014 | 0.10 | 0.09 | 1.78 | 0.02 | 0.022 | 0.037 | 0.000 | 0.000 |
| Example 2 | | | | | | | | | | | | | |
| Comparative | 0.22 | 0.08 | 1.13 | 0.022 | 0.018 | 0.07 | 0.08 | 1.75 | 0.11 | 0.019 | 0.035 | 0.000 | 0.000 |
| Example 3 | | | | | | | | | | | | | |
| Comparative | 0.21 | 0.13 | 0.85 | 0.011 | 0.023 | 0.08 | 0.09 | 2.75 | 0.07 | 0.021 | 0.034 | 0.000 | 0.000 |
| Example 4 | | | | | | | | | | | | | |
| Comparative | 0.20 | 0.08 | 0.82 | 0.048 | 0.012 | 0.09 | 0.08 | 1.83 | 0.06 | 0.024 | 0.031 | 0.000 | 0.000 |
| Example 5 | | | | | | | | | | | | | |
| Comparative | 0.18 | 0.12 | 0.71 | 0.021 | 0.069 | 0.07 | 0.10 | 1.90 | 0.01 | 0.021 | 0.035 | 0.000 | 0.000 |
| Example 6 | | | | | | | | | | | | | |
| Comparative | 0.21 | 0.22 | 0.26 | 0.015 | 0.012 | 0.12 | 0.05 | 1.41 | 0.03 | 0.021 | 0.045 | 0.000 | 0.000 |
| Example 7 | | | | | | | | | | | | | |
| Comparative | 0.20 | 0.19 | 0.70 | 0.018 | 0.007 | 0.10 | 0.04 | 0.98 | 0.02 | 0.025 | 0.042 | 0.000 | 0.000 |
| Example 8 | | | | | | | | | | | | | |
| Comparative | 0.19 | 0.07 | 0.79 | 0.013 | 0.013 | 0.10 | 0.09 | 1.82 | 0.01 | 0.003 | 0.032 | 0.000 | 0.001 |
| Example 9 | | | | | | | | | | | | | |
| Comparative | 0.18 | 0.09 | 0.70 | 0.023 | 0.011 | 0.08 | 0.10 | 1.75 | 0.02 | 0.022 | 0.004 | 0.000 | 0.000 |
| Example 10 | | | | | | | | | | | | | |
| Comparative | 0.20 | 0.05 | 0.73 | 0.015 | 0.008 | 0.05 | 0.08 | 1.81 | 0.02 | 0.025 | 0.046 | 0.086 | 0.000 |
| Example 11 | | | | | | | | | | | | | |
| Comparative | 0.22 | 0.07 | 0.76 | 0.009 | 0.013 | 0.08 | 0.12 | 1.76 | 0.03 | 0.022 | 0.036 | 0.000 | 0.092 |
| Example 12 | | | | | | | | | | | | | |

In detail, a steel ingot having a predetermined component composition was hot-forged and worked into a coarse compact of a pulley (S1). At this time, the forging load was measured. Next, the steel ingot was held in a furnace at 910° C. for 1.5 hours, and was normalized through air cooling (S2). Furthermore, the steel ingot was mechanically worked into the shape of the pulley (S3), and a eutectic gas carburization and quenching-tempering thermal treatment were carried out (S4). At the end, polishing was carried out as a finishing work using a grinding stone (S5) so as to obtain the testing actual pulley 1.

Next, the respective tests and measurement methods of the testing actual pulley 1 will be described.

Firstly, the deformation resistance during hot forging was evaluated based on the forging load measured during the above hot forging (S1). The measurement results of the forging load were expressed as ratios (forging load ratios) when the forging load of Comparative example 1 was taken as 1.

In the abrasion resistance test, the testing actual pulley 1 (refer to FIG. 1) was combined on the input side of an actual belt-type CVT, the transmission ratio was fixed to 2.367 (Low), the CVT was driven for 24 hours at a rotation speed of 4500 r.p.m., an input torque of 145 N·m, and an oil temperature of 100° C., and the abrasion resistance was evaluated using the abrasion amount. That is, the abrasion amount of the testing actual pulley 1 at the contact portion with the steel belt 3 (refer to FIG. 1) after the driving was measured. The measurement results were expressed using ratios (abrasion ratios) when the abrasion amount of the testing actual pulley 1 (Comparative example 1) having the component composition of JIS G4053 SCM420 which is one variety of conventional steel for a pulley of a belt-type CVT was taken as 1.

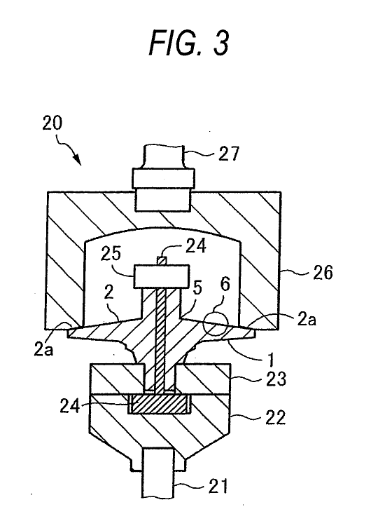

In the bending fatigue test, the bending fatigue was evaluated with the test results obtained using an actual pulley bending fatigue tester 20 as shown in FIG. 3. In detail, the central hole of the testing actual pulley 1 was made to penetrate an inner rod 24 extending upward from a flange 23, the testing actual pulley 1 was mounted on the flange 23, and a lock nut 25 was screwed into the protruding end portion of the inner rod 24 from the testing actual pulley 1. Thereby, the testing actual pulley 1 was pressed to the flange 23 from the upper portion so as to be fixed. In addition, the flange 23 was fixed to the upper portion of a load transfer seat 22 connected to a piston 21. Furthermore, a pulley receiver 26 was brought into contact from the upper portion so as to come into contact with the circumferential edge 2a of a contact area 2 with the steel belt 3 (refer to FIG. 1) in the testing actual pulley 1. A connecting rod 27 for transferring a load to a load cell not shown in the figures was connected to the pulley receiver 26. When the testing actual pulley 1 was brought upward using the piston 21, a load was added to the circumferential edge 2a of the testing actual pulley 1 from the pulley receiver 26, and a bending load was supplied to an R portion 5 on the contact area 2 side.

Here, in the bending fatigue test, the load was changed so that the piston 21 produced a stress ratio of 0.05 at a frequency of 20 Hz, and the stress at which the piston did not rupture at a number of repetitions of 1×10⁷ was obtained as the fatigue limit stress. Meanwhile, the measurement results were expressed using ratios (fatigue limit stress ratios) when the fatigue limit stress at the above-mentioned testing actual pulley 1 (Comparative example 1) having the component composition of JIS G4053 SCM420 as described above was taken as 1.

In the hardness test, at the contact area 2 with the steel belt 3 in the testing actual pulley 1 which had been subjected to an abrasion resistance test, a test specimen was cut out from a collection position 6 (refer to FIG. 3) in the substantially central portion in the radius direction in a manner in which the surface layer was included, and the hardness in the vicinity of the contact area 2 in cross-section, that is, at a location of a depth of 0.05 mm from the surface, was measured using a Vickers hardness tester. Meanwhile, in the Vickers hardness test, the load was 300 g, the measurement was carried out at 5 points, and the hardness was expressed using the average value.

Meanwhile, the crystal grain size was measured together with the hardness test. On the cross-section of the hardness test specimen, old austenite crystal grains were observed using an optical microscope based on JIS G0551, and the grain size number of the largest crystal grain in the observation view was employed. In Table 2, cases in which the grain size number was less than 5 are indicated by “Poor” considering that abnormally coarsened crystal grains were present, and other cases are indicated by “Good”.

The results of the above respective tests and measurements are shown in Table 2.

TABLE 2

| | | Abrasion | | Bending fatigue | | | | |
|---|---|---|---|---|---|---|---|---|
| | | Fracture | | | Grain boundary | | Hot forgeability | |
| | Hardness | toughness | | Crystal grain | oxidation | Fatigue limit | Forging | Forging load |
| | Hv | parameter ≧ 2.0 | Abrasion ratio | determination | parameter ≦ 4.3 | stress ratio | parameter ≦ 8.0 | ratio |
| Example 1 | 703 | 2.57 | 0.62 | Good | 3.41 | 1.11 | 5.52 | 0.87 |
| Example 2 | 694 | 2.83 | 0.64 | Good | 3.48 | 1.17 | 5.69 | 0.92 |
| Example 3 | 692 | 2.69 | 0.67 | Good | 3.27 | 1.10 | 6.04 | 0.94 |
| Example 4 | 685 | 2.05 | 0.74 | Good | 3.03 | 1.20 | 6.11 | 0.93 |
| Example 5 | 653 | 3.43 | 0.34 | Good | 4.28 | 1.03 | 7.94 | 0.96 |
| Example 6 | 705 | 3.14 | 0.27 | Good | 3.58 | 1.17 | 5.83 | 0.90 |
| Example 7 | 669 | 3.24 | 0.43 | Good | 4.12 | 1.06 | 6.55 | 0.92 |
| Example 8 | 709 | 3.53 | 0.34 | Good | 3.63 | 1.12 | 5.69 | 0.91 |
| Example 9 | 692 | 3.13 | 0.45 | Good | 3.35 | 1.08 | 5.31 | 0.86 |
| Example 10 | 712 | 3.62 | 0.58 | Good | 2.53 | 1.21 | 7.88 | 0.97 |
| Example 11 | 701 | 4.55 | 0.20 | Good | 3.62 | 1.19 | 6.70 | 0.91 |
| Example 12 | 711 | 3.54 | 0.46 | Good | 3.24 | 1.11 | 7.34 | 0.93 |
| Example 13 | 706 | 3.12 | 0.38 | Good | 2.62 | 1.15 | 6.28 | 0.88 |
| Comparative | 702 | 1.00 | 1.00 | Good | 4.46 | 1.00 | 9.41 | 1.00 |
| Example 1 | | | | | | | | |
| Comparative | 692 | 2.55 | 0.57 | Good | 6.00 | 0.87 | 7.62 | 0.91 |
| Example 2 | | | | | | | | |
| Comparative | 705 | 1.42 | 0.97 | Good | 3.68 | 1.13 | 9.18 | 1.04 |
| Example 3 | | | | | | | | |
| Comparative | 714 | 4.39 | 0.20 | Good | 4.90 | 0.93 | 8.83 | 1.00 |
| Example 4 | | | | | | | | |
| Comparative | 703 | 2.38 | 1.12 | Good | 3.45 | 0.93 | 7.05 | 0.90 |
| Example 5 | | | | | | | | |
| Comparative | 695 | 2.90 | 1.10 | Good | 3.81 | 0.91 | 5.90 | 0.90 |
| Example 6 | | | | | | | | |
| Comparative | 621 | 2.75 | 4.09 | Good | 3.87 | 0.83 | 4.84 | 0.88 |
| Example 7 | | | | | | | | |
| Comparative | 631 | 0.53 | 3.20 | Good | 3.58 | 0.86 | 5.47 | 0.87 |
| Example 8 | | | | | | | | |
| Comparative | 703 | 2.44 | 0.75 | Poor | 3.31 | 0.98 | 5.78 | 0.88 |
| Example 9 | | | | | | | | |
| Comparative | 710 | 2.61 | 0.71 | Poor | 3.35 | 0.96 | 5.70 | 0.93 |
| Example 10 | | | | | | | | |
| Comparative | 689 | 2.53 | 0.69 | Good | 3.04 | 1.18 | 9.23 | 1.03 |
| Example 11 | | | | | | | | |
| Comparative | 699 | 2.61 | 0.53 | Good | 3.22 | 1.16 | 9.64 | 1.05 |
| Example 12 | | | | | | | | |

Fracture toughness parameter: −2.73 × [Mn] + 6.42 × [Ni] + 2.20 × [Cr] + 1.25 × [Mo]
Grain boundary oxidation parameter: 10 × [Si] + [Mn] + [Cr]
Forging parameter: 7.00 × [Si] + 3.60 × [Mn] + 1.20 × [Cr] + 22.3 × [Mo] + 42.3 × [Nb] + 39.5 × [Ti]

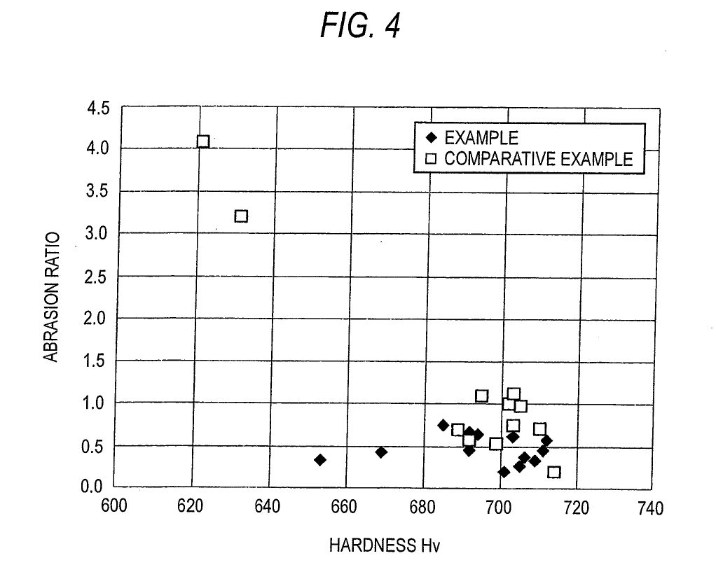

Generally, the abrasion resistance is significantly influenced by the hardness. As shown in FIG. 4, it was determined from the results of the hardness test and the abrasion resistance test that the abrasion resistance is higher than in a conventional material, that is, the abrasion ratio can be decreased to less than 1 in a case where the hardness is 650 Hv or more.

Here, the mechanical characteristics such as abrasion, fracture toughness, and fatigue strength as described below depend on the size of crystal grains, and, as shown in Table 2, abnormal coarsening of crystal grains was not observed in the Examples of the present invention. This is considered to result from precipitation of fine Al nitrides.

Firstly, as a mode of abrasion of the belt-type CVT pulley, abrasion resulting from the impact load caused by the contact with the steel belt is considered. This is because, when fine cracking occurs, fine separation occurs and abrasion develops. In contrast to this, it is thought that abrasion can be suppressed by suppressing the occurrence of fine cracking, that is, by increasing the fracture toughness. As elements added to the steel which influence the fracture toughness, Mn, Ni, Cr and Mo can be selected. Therefore, for several steels including Examples 1 to 13, regression calculation was carried out on the relationship between the contents of the above elements and the abrasion ratios, and the following formula that supplies the fracture toughness parameter was obtained.

−2.73×[Mn]+6.42×[Ni]+2.20×[Cr]+1.25×[Mo]

Here, the mass % of an element M is indicated by [M]. Table 2 shows the fracture toughness parameters of Examples 1 to 13 and Comparative examples 1 to 12.

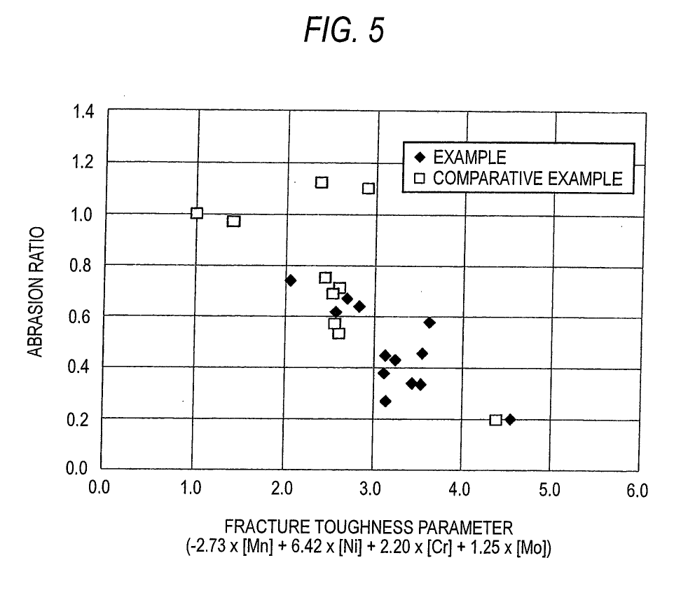

As shown in FIG. 5, in the relationship between the fracture toughness parameter and the abrasion ratio, it is determined that the abrasion resistance is higher than in a conventional material, that is, the abrasion ratio can be decreased to less than 1 in a case where the fracture toughness parameter is 2.0 or more. That is, the abrasion ratio can be decreased to less than 1 in a case where the following formula 1 is satisfied.

−2.73×[Mn]+6.42×[Ni]+2.20×[Cr]+1.25×[Mo]≧2.0 (formula 1)

Next, as one cause degrading the fatigue strength, grain boundary oxidation using gas carburization is considered. When oxygen in a carburization atmosphere intrudes into a steel through crystal grain boundaries as diffusion paths, Si, Mn and Cr which have a strong affinity to oxygen diffuse into the crystal grain boundaries from the basis material, and deficient areas are generated in the basis material. That is, in the basis material around the grain boundaries into which oxygen has intruded, since the hardenability degrades, martensite is not sufficiently generated, and the fatigue strength degrades. Therefore, for several steels including Examples 1 to 13, regression calculation was carried out on the relationship between the contents of the above elements and the fatigue limit stress ratio, and the following formula that supplies the grain boundary oxidation parameter was obtained.

10×[Si]+[Mn]+[Cr]

Table 2 shows the grain boundary oxidation parameters of Examples 1 to 13 and Comparative examples 1 to 12.

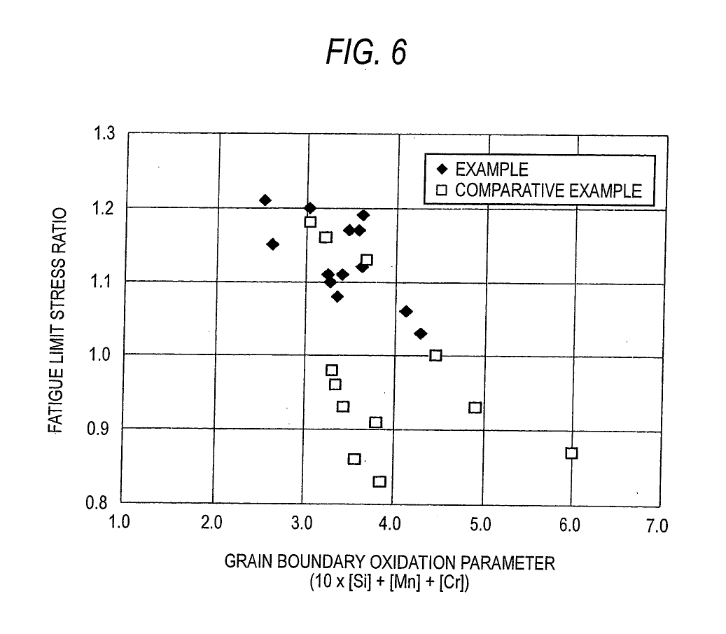

As shown in FIG. 6, in the relationship between the grain boundary oxidation parameter and the fatigue limit stress ratio, it is determined that the fatigue strength is higher than in a conventional material, that is, the fatigue limit stress ratio can be increased to more than 1 in a case where the grain boundary oxidation parameter is 4.3 or less. That is, the fatigue limit stress ratio can be increased to more than 1 in a case where the following formula (2) is satisfied.

10×[Si]+[Mn]+[Cr]≦4.3 (formula 2)

Furthermore, as elements added to increase the deformation resistance when hot forging is carried out on the shape of the belt-type CVT pulley as shown in FIG. 1, Si, Mn, Cr, Mo, Nb and Ti are considered. Therefore, for several steels including Examples 1 to 13, regression calculation was carried out on the relationship between the contents of the above elements and the forging load ratio, and the following formula that supplies the forging parameter was obtained.

7.00×[Si]+3.60×[Mn]+1.20×[Cr]+22.3×[Mo]+42.3×[Nb]+39.5×[Ti]

Table 2 shows the forging parameters of Examples 1 to 13 and Comparative examples 1 to 12.

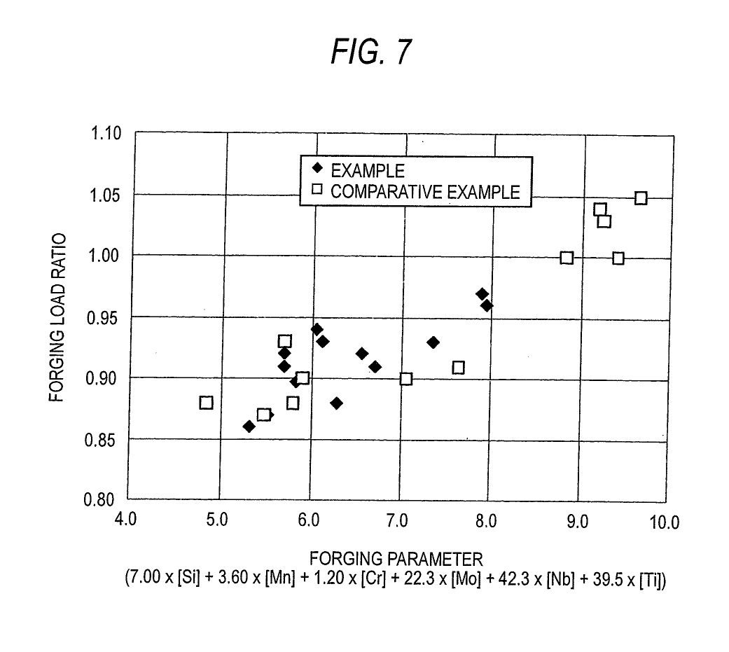

As shown in FIG. 7, in the relationship between the forging parameter and the forging load ratio, it is determined that the deformation resistance is equal to or less than in a conventional material, that is, the forging load ratio can be made to be 1 or less in a case where the forging parameter is 8.0 or less. That is, the deformation resistance is equal to or less than in a material of the related art in a case where the following formula 3 is satisfied.

7.00×[Si]+3.60×[Mn]+1.20×[Cr]+22.3×[Mo]+42.3×[Nb]+39.5×[Ti]≦8.0 (formula 3)

Meanwhile, it is thought that, in the y region, the deformation resistance during hot forging increases when the misfit of elements, which is to be added, with Fe atoms increases, and the formula 3 shows that tendency.

As described above, in a steel for a pulley in a belt-type CVT, in order to increase the abrasion resistance and the fatigue strength without increasing the deformation resistance more than in a conventional material during hot forging, it is necessary to satisfy the above formulae 1 to 3 and have a hardness of 650 Hv or more.

Meanwhile, as shown in Table 2, since Examples 1 to 13 satisfy all of the above requirements, they can improve the abrasion resistance and the fatigue strength compared to a conventional material, and furthermore, can make the deformation resistance during hot forging equal to or less than in a conventional material.

Furthermore, the results of Comparative examples 1 to 12 will be described respectively.

Comparative example 1 shows a testing actual pulley 1 made of SCM420 material, and, as described above, has a value of 1 regarding all pf abrasion ratio, fatigue limit stress ratio, and forging load ratio in order to provide the criteria.

Comparative example 2 had a larger content of Si than those in the component compositions of Examples 1 to 13, and did not satisfy the formula 2. The grain boundary oxidation parameter was large, the fatigue limit stress ratio was low, and the fatigue strength was low.

Comparative example 3 had a larger content of Mn than those in the component compositions of Examples 1 to 13, and did not satisfy the formula 3. The forging parameter was large, the forging load ratio was large, and the hot forging workability as a belt-type CVT pulley was impaired.

Comparative example 4 had a larger content of Cr than those in the component compositions of Examples 1 to 13, and did not satisfy the formula 2. The grain boundary oxidation parameter was large, the fatigue limit stress ratio was low, and the fatigue strength was low.

Comparative examples 5 and 6 had larger contents of P and S respectively than those in the component compositions of Examples 1 to 13, and although they satisfied the hardness or the requirements of the formulae 1 to 3, they had a large abrasion ratio and a low fatigue limit stress ratio. It is thought that, in Comparative example 5, crystal grain boundaries became brittle due to P, and, in Comparative example 6, MnS inclusions were generated due to S, and the stress concentration source was increased.

Comparative examples 7 and 8 had smaller contents of Mn and Cr respectively than those in the component compositions of Examples 1 to 13, and had a hardness lower than 650 Hv, a large abrasion ratio, and a low fatigue limit stress ratio. It is thought that, due to degradation of the hardenability, it was not possible to secure the necessary mechanical strength as a belt-type CVT pulley.

Comparative examples 9 and 10 had smaller contents of N and Al respectively than those in the component compositions of Examples 1 to 13, and although they satisfied the hardness or the requirements of the formulae 1 to 3, they had a low fatigue limit stress ratio. It is thought that the low fatigue limit stress ratio results from the fact that it was not possible to sufficiently suppress coarsening of crystal grains during heating for carburization in both examples (refer to Table 2). Therefore, addition of N and Al is essential.

Comparative examples 11 and 12 had larger contents of Nb and Ti respectively than those in Examples 12 to 13, did not satisfy the formula 3, and had a large forging parameter. That is, the hot forging workability as a belt-type CVT pulley was impaired.

Based on the above results, within a scope in which the characteristics of belt-type CVT pulleys obtained using steel having the component compositions shown in the above Examples 1 to 13 are not impaired, the ranges of the respective composition components were specified. Firstly, C, Mn, Cr, N and Al, which are essentially added elements, will be described.

C is an essentially added element which is important for securing the mechanical strength required as a belt-type CVT pulley. When the added amount of C is too small, the mechanical strength cannot be secured and, particularly, the mechanical strength cannot be secured in the core portion (inside) of a material after a carburization treatment. On the other hand, when the added amount of C is too large, the hot forgeability or mechanical workability degrades. Therefore, C is included in a range of, in terms of mass %, 0.15% to 0.25%. The lower limit of the amount of C is preferably 0.17%. The upper limit of the amount of C is preferably 0.23%.

Mn is required to increase the hardenability of steel and secure the mechanical strength required as a belt-type CVT pulley. When the added amount of Mn is too small, steel is not sufficiently quenched and the abrasion resistance or fatigue strength required as a belt-type CVT pulley cannot be secured. On the other hand, when the added amount of Mn is too large, the abrasion resistance required as a belt-type CVT pulley cannot be secured. Furthermore, grain boundary oxidation is accelerated during a carburization treatment, and the fatigue strength required as a belt-type CVT pulley cannot be secured. Therefore, Mn is included in a range of, in terms of mass %, 0.40% to 1.00%. The lower limit of the amount of Mn is preferably 0.60%. The amount of Mn is preferably less than 1.00%.

Similarly to Mn, Cr is required to increase the hardenability of steel and secure the mechanical strength required as a belt-type CVT pulley. When the added amount of Cr is too large, the hardness increases more than necessary, and the mechanical workability thus degrades. In addition, the fatigue strength required as a belt-type CVT pulley cannot be secured. Therefore, Cr is included in a range of, in terms of mass %, more than 1.80% and 2.20% or less. The lower limit of the amount of Cr is preferably 1.80%. The amount of Cr is preferably 2.00% or less, and more preferably less than 2.00%.

N combines with Al which will be described below so as to generate fine nitrides or carbonitrides, and is required to suppress coarsening of crystal grains during a carburization treatment. When the added amount of N is too small, it is not possible to sufficiently suppress coarsening of crystal grains, and the fatigue strength required as a belt-type CVT pulley cannot be secured. On the other hand, when the added amount of N is too large, steel is made to become brittle, and the impact characteristics required as a belt-type CVT pulley are adversely influenced. Therefore, N is included in a range of, in terms of mass %, 0.005% to 0.030%.

Al is a deoxidizing agent of molten steel and, although it can be generally considered as an impurity, it is actively added in the present embodiment. That is, Al accelerates generation of the above-mentioned fine nitrides or carbonitrides, and suppresses coarsening of crystal grains during a carburization treatment. When the added amount of Al is too small, it is not possible to sufficiently suppress coarsening of the crystal grains, and the fatigue strength required as a belt-type CVT pulley cannot be secured. On the other hand, when the added amount of Al is too large, coarse Al nitrides are generated, it becomes difficult to secure the fatigue strength required as a belt-type CVT pulley, and the impact characteristics also deteriorate. Therefore, Al is included in a range of, in terms of mass %, 0.010% to 0.060%, and preferably in a range of 0.010% to 0.050%.

Next, the arbitrarily added elements will be described. For the arbitrarily added elements, the upper limit values were specified within a scope in which the characteristics as a belt-type CVT pulley obtained by the essentially added elements described above are not impaired.

Si is a deoxidizing agent of molten steel, but also has an effect of increasing the hardenability of steel. However, when the content of Si is too large, grain boundary oxidation during a carburization treatment is accelerated. That is, it becomes impossible to secure the fatigue strength required as a belt-type CVT pulley. Therefore, in a case where Si is contained, Si is contained in a range of, in terms of mass %, 0.20% or less. The upper limit of the amount of Si is preferably 0.15%. In addition, in a case where Si is contained, the lower limit of the content of Si is not particularly limited but, for example, more than 0%. The lower limit of the amount of Si is preferably 0.01%.

P makes crystal grain boundaries brittle so as to degrade the mechanical strength and leads to a decrease in the fatigue strength required as a belt-type CVT pulley. However, when the content of P is certain amount or less, the decrease in the mechanical strength is minor. In addition, since decreasing the content of P makes a purification process long, an increase in the costs may result. Therefore, in a case where P is contained, P is contained in a range of, in terms of mass %, 0.03% or less. In addition, in a case where P is contained, the lower limit of the content of P is not particularly limited but, for example, more than 0%. The lower limit of the amount of P is preferably 0.002%.

Since S combines with Mn so as to generate MnS inclusions, when S is excessively contained, the amount of inclusions which act as the points of origin of stress concentration is increased, and it becomes difficult to secure the fatigue strength required as a belt-type CVT pulley. However, when the content of S is certain amount or less, the decrease in the fatigue strength is quite minor. Therefore, in a case where S is contained, S is contained in a range of, in terms of mass %, 0.05% or less, and preferably in a range of 0.03% or less. In addition, in a case where S is contained, the lower limit of the content of S is not particularly limited but, for example, more than 0%. The lower limit of the amount of S is preferably 0.005%.

Cu improves the hardenability of steel. However, excessive addition may result in an increase in the costs. Therefore, in a case where Cu is contained, Cu is contained in a range of, in terms of mass %, 0.3% or less. In addition, in a case where Cu is contained, the lower limit of the content of Cu is not particularly limited but, for example, more than 0%. The lower limit of the amount of Cu is preferably 0.01%.

Ni improves the hardenability of steel, and effectively secures the necessary mechanical strength as a belt-type CVT pulley. However, excessive addition may result in an increase in the costs. Therefore, in a case where Ni is contained, Ni is contained in a range of, in terms of mass %, 0.3% or less. In addition, in a case where Ni is contained, the lower limit of the content of Ni is not particularly limited but, for example, more than 0%. The lower limit of the amount of Ni is preferably 0.01%.

Mo suppresses degradation of the hardness during tempering for a carburization treatment, and supplies the surface layer hardness required as a belt-type CVT pulley after the carburization treatment. However, excessive addition may result in an increase in the costs. Therefore, in a case where Mo is contained, Mo is contained in a range of, in terms of mass %, 0.2% or less. In addition, in a case where Mo is contained, the lower limit of the content of Mo is not particularly limited but, for example, more than 0%. The lower limit of the amount of Mo is preferably 0.01%.

Nb generates fine nitrides or carbonitrides, and can suppress coarsening of crystal grains due to heating during a carburization treatment. However, when the content of Nb is too large, not only the hot forgeability degrades, but also precipitates including coarse Nb are generated so as to result in degradation of the mechanical workability. Therefore, in a case where Nb is contained, Nb is contained in a range of, in terms of mass %, 0.05% or less. In addition, in a case where Nb is contained, the lower limit of the content of Nb is not particularly limited but, for example, more than 0%. The lower limit of the amount of Nb is preferably 0.005%.

Ti generates fine nitrides, and can suppress coarsening of crystal grains due to heating during a carburization treatment. However, when the content of Ti is too large, not only the hot forgeability degrades, but also precipitates including coarse Ti are generated so as to result in degradation of the mechanical workability. Therefore, in a case where Ti is contained, Ti is contained in a range of, in terms of mass %, 0.05% or less. In addition, in a case where Ti is contained, the lower limit of the content of Ti is not particularly limited but, for example, more than 0%. The lower limit of the amount of Ti is preferably 0.005%.

Thus far, typical examples according to the invention and modified examples based on the examples have been described, but the invention is not necessarily limited thereto. The invention can be applied not only to a belt-type CVT pulley but also to, for example, carburized components for which the forging load during hot forging needs to be suppressed, such as large gear components. As such, a person skilled in the art can find a variety of alternative examples and modified examples within the scope of the attached claims.

This application is based on Japanese patent application No. 2012-099407 filed Apr. 25, 2012, the entire contents thereof being hereby incorporated by reference.

What is claimed is:

1. A steel for a belt-type CVT pulley made of chromium steel or chromium molybdenum steel, the steel for a belt-type CVT pulley having a component composition that satisfies:
−2.73×[Mn]+6.42×[Ni]+2.20×[Cr]+1.25×[Mo]≧2.0, (formula 1):
10×[Si]+[Mn]+[Cr]≦4.3, and (formula 2):
7.00×[Si]+3.60×[Mn]+1.20×[Cr]+22.3×[Mo]+42.3×[Nb]+39.5×[Ti]≦8.0, (formula 3):
wherein [M] represents a mass % of an element M;
and
the steel for a belt-type CVT pulley comprising, in terms of mass %, as essentially added elements,
0.15% to 0.25% of C,
0.40% to 1.00% of Mn,
more than 1.80% and 2.20% or less of Cr,
0.005% to 0.030% of N, and
0.010% to 0.060% of Al, and
as arbitrarily added elements,
0.20% or less of Si,
0.03% or less of P,
0.05% or less of S,
0.3% or less of Cu,
0.3% or less of Ni, and
0.2% or less of Mo,
with the remainder being Fe and inevitable impurities.

2. The steel for a belt-type CVT pulley according to claim 1, further comprising, as an arbitrarily added element, at least one of:
0.05% or less of Nb, and
0.05% or less of Ti.

3. A belt-type CVT pulley, which comprises the steel for a belt-type CVT pulley according to claim 1 worked into a predetermined shape and then subjected to a carburization treatment, said belt-type CVT pulley having a surface layer hardness of 650 Hv or more.

4. The belt-type CVT pulley according to claim 3, wherein the steel for a belt-type CVT pulley further comprises, as an arbitrarily added element, at least one of:
0.05% or less of Nb, and
0.05% or less of Ti.
